(19) United States
(12) Patent Application Publication
(10) Pub. No.: US 2024/0034173 A1
(43) Pub. Date: Feb. 1, 2024

(54) PARKING LOT MANAGEMENT METHOD, STORAGE MEDIUM, AND COMPUTER DEVICE

(71) Applicant: TOYOTA JIDOSHA KABUSHIKI KAISHA, Toyota-shi (JP)

(72) Inventors: Shigeki KINOMURA, Toyota-shi (JP); Hiroki TAKABATAKE, Chiryu-shi (JP); Hisashi FUJISAWA, Toyota-shi (JP); Atsushi OKI, Nagoya-shi (JP); Hiromitsu FUJII, Kariya-shi (US)

(73) Assignee: TOYOTA JIDOSHA KABUSHIKI KAISHA, Toyota-shi (JP)

(21) Appl. No.: 18/316,180

(22) Filed: May 11, 2023

(30) Foreign Application Priority Data
Jul. 29, 2022 (JP) 2022-121782

(51) Int. Cl. B60L 53/50; B60L 53/30; G08G 1/14

(52) U.S. Cl. CPC B60L 53/50; B60L 53/305; G08G 1/149

(57) ABSTRACT

A parking lot management method for managing a parking lot includes requesting energy management to a vehicle parked in a parking slot and displaying a remaining time until a parking time limit of the vehicle. Displaying the remaining time includes increasing the remaining time when the vehicle executes the energy management as compared with the remaining time when the vehicle does not execute the energy management.

### CROSS-REFERENCE TO RELATED APPLICATION

This application claims priority to Japanese Patent Application No. 2022-121782 filed on Jul. 29, 2022, incorporated herein by reference in its entirety.

### BACKGROUND

### 1. Technical Field

The present disclosure relates to a parking lot management method, a storage medium, and a computer device.

### 2. Description of Related Art

Conventionally, a technique for charging a power storage device mounted on a parked vehicle using a power supply facility installed in a parking lot is known. For example, Japanese Unexamined Patent Application Publication No. 2012-139008 (JP 2012-139008 A) discloses a battery electric vehicle charging device that causes a display device to display charging time as charging completion prediction information.

### SUMMARY

In recent years, with the spread of an electrified vehicle (for example, a battery electric vehicle), the number of facilities (stores, etc.) in which electric vehicle service equipment (EVSE) is installed in a parking lot within the premises has been increasing. Further, in the parking lot, there is a problem that the vehicle continues to stay in the parking lot even after charging of a power storage device mounted on the vehicle is completed.

In general, parking a vehicle for a long time in a parking lot of a store is considered to be a disadvantage for a store owner because it results in a lower turnover rate of customers. Therefore, when a store clerk finds such a vehicle, the store clerk may put a sticker on the vehicle and ask the vehicle to exit. However, there is a possibility that utilizing the vehicle parked in the parking lot of the store for management of the store will be advantageous for both the store owner and a vehicle user. For example, the parked vehicle may be used for energy management.

Conventionally, there is no concept of utilizing the vehicle parked in the parking lot, and the vehicle parked in the parking lot for a long time is uniformly asked to exit.

The present disclosure has been made to solve the above issue, and an object of the present disclosure is to suppress long-time parking that is disadvantageous while promoting utilization of the vehicle parked in the parking lot.

With a mode according to a first aspect of the present disclosure, a parking lot management method described below is provided.

(First aspect) The parking lot management method is a method for managing a parking lot. The parking lot includes a parking slot and a power supply facility configured to be able to charge a power storage device mounted on a vehicle parked in the parking slot. The parking lot management method includes:
requesting energy management to the vehicle parked in the parking slot; and
displaying a remaining time until a parking time limit of the vehicle. Displaying the remaining time includes increasing the remaining time when the vehicle executes the energy management as compared with the remaining time when the vehicle does not execute the energy management.

According to the above method, for the vehicle parked in a certain parking slot, the remaining time until the parking time limit (that is, the time limit for which a user is allowed to park the vehicle) is displayed. By showing the remaining time to a surrounding area, deterrence works by surrounding eyes, and the long-time parking that exceeds the parking time limit (that is, disadvantageous long-time parking) is suppressed. Further, by increasing the remaining time when the vehicle executes the energy management as compared with the remaining time when the vehicle does not execute the energy management, it is possible to prompt the vehicle to participate in the energy management. This makes it easier for the vehicles parked in the parking lot to be utilized.

The vehicle may be an electrified vehicle (xEV) that uses power as a power source in whole or in part. The xEV includes a battery electric vehicle (BEV), a plug-in hybrid electric vehicle (PHEV), a fuel cell electric vehicle (FCEV), and the like.

The parking lot management method according to the first aspect can have a configuration described in any one of second to sixth aspects indicated below.

(Second aspect) The parking lot management method according to the first aspect further includes the following features. Displaying the remaining time includes:
determining the remaining time based on a reply with acceptance or rejection from a user of the vehicle to a request of the energy management; and
displaying the determined remaining time on a display device.

According to the above method, for example, the remaining time until the parking time limit is determined such that the remaining time when the user of the vehicle accepts the request for the energy management is longer than the remaining time when the user of the vehicle rejects the request for the energy management. Then, the display device displays the remaining time determined as described above. As a result, when the vehicle executes the energy management, it is possible to display the remaining time longer than the remaining time when the vehicle does not execute the energy management.

(Third aspect) The parking lot management method according to the first aspect further includes the following features. Displaying the remaining time includes: displaying the remaining time while the remaining time is counted down when the vehicle is
not executing the energy management; and
displaying the remaining time without counting down the remaining time when the vehicle is executing the energy management.

According to the above method, when the vehicle does not execute the energy management, the remaining time is counted down, and the remaining time that is sequentially counted down is displayed. On the other hand, when the vehicle is executing the energy management, the remaining time is not counted down, and the unchanged remaining time is displayed. As a result, when the vehicle executes the energy management, it is possible to display the remaining time longer than the remaining time when the vehicle does not execute the energy management.

Displaying the remaining time while the remaining time is counted down means that the displayed remaining time decreases as time elapses. Further, displaying the remaining time without counting down the remaining time means that the countdown of the displayed remaining time is stopped (that is, the displayed remaining time does not decrease as time elapses).

(Fourth aspect) The parking lot management method according to any one of the first to the third aspects further includes the following features. Displaying the remaining time further includes increasing the remaining time when a user of the vehicle uses a facility as compared with the remaining time when the user of the vehicle does not use the facility.

As described above, by increasing the remaining time when the user of the vehicle uses the facility as compared with the remaining time when the user of the vehicle does not use the facility, it is possible to prompt the user of the vehicle to use the facility. An increase in the number of customers using the facility is advantageous to the facility. By changing the remaining time according to whether the facility is used as described above, it is possible to appropriately suppress the long-time parking that is disadvantageous to the facility.

(Fifth aspect) The parking lot management method according to any one of the first to the fourth aspects further includes the following features. The parking lot management method further includes executing a process of prompting the vehicle to exit from the parking slot when the parking time limit has passed.

As described above, by executing the process of prompting the vehicle to exit from the parking slot when the parking time limit has passed, it is possible to suppress the disadvantageous long-time parking.

(Sixth aspect) The parking lot management method according to the fifth aspect further includes the following features. Executing the process of prompting the vehicle to exit includes at least one of:
issuing a warning by a warning light provided for the parking slot;
charging a user of the vehicle with a parking fee; and
discharging the power storage device mounted on the vehicle.

Each of the above processes is particularly effective as a process of prompting the vehicle to exit from the parking lot.

With a mode according to another aspect, a storage medium storing a program that causes a computer to execute the parking lot management method according to any one of the first to the sixth aspects is provided. In one mode, a computer device including a storage device for storing the program and a processor for executing the program stored in the storage device is provided. In another mode, a computer device for distributing the program is provided.

According to the present disclosure, it is possible to suppress the disadvantageous long-time parking while promoting utilization of the vehicle parked in the parking lot.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating an outline of a parking lot management system according to an embodiment of the present disclosure;

FIG. 2 is a diagram showing a configuration of a control system and a power facility shown in FIG. 1;

FIG. 3 is a diagram illustrating energy management using electric vehicle service equipment (EVSE) in a store shown in FIG. 1;

FIG. 4 is a flowchart showing a process related to energy management in a parking lot management method according to the embodiment of the present disclosure;

FIG. 5 is a flowchart showing a process related to display control in the parking lot management method according to the embodiment of the present disclosure;

FIG. 6 is a flowchart showing details of the display control shown in FIG. 5; and

FIG. 7 is a flowchart showing a modification of the process shown in FIG. 6.

### DETAILED DESCRIPTION OF EMBODIMENTS

An embodiment of the present disclosure will be described in detail with reference to the drawings. In the drawings, the same or corresponding parts are denoted by the same reference signs and the description thereof will not be repeated.

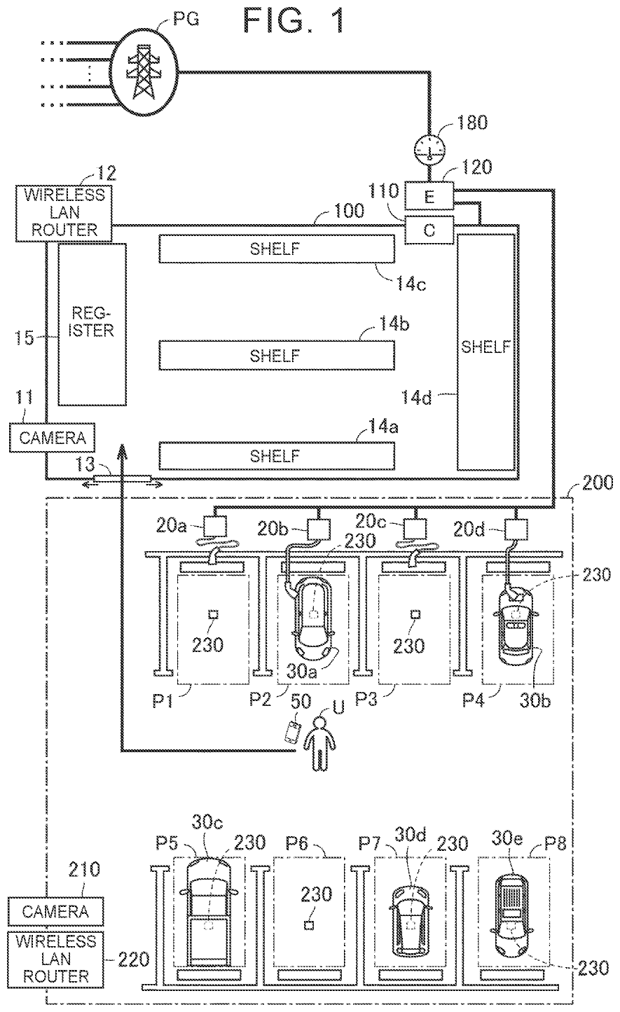

FIG. 1 is a diagram illustrating an outline of a parking lot management system according to the embodiment of the present disclosure. Referring to FIG. 1, the parking lot management system according to the present embodiment manages a parking lot 200 of a store 100. In the present embodiment, the store 100 is a convenience store (hereinafter also simply referred to as a “convenience store”). However, the business type of the store 100 is not limited to this, and is decided as appropriate. The store 100 may be, for example, a department store, a supermarket, or a shopping mall store.

A user U is a customer of the store 100. A mobile terminal 50 is a terminal carried by the user U. In the present embodiment, a smartphone equipped with a touch panel display is adopted as the mobile terminal 50. The smartphone has a built-in computer. However, the mobile terminal 50 is not limited to this, and any mobile terminal can be adopted as the mobile terminal 50. For example, a laptop, a tablet terminal, a mobile game machine, a wearable device (a smart watch, smart glasses, smart gloves, etc.), an electronic key, etc. can also be adopted as the mobile terminal 50.

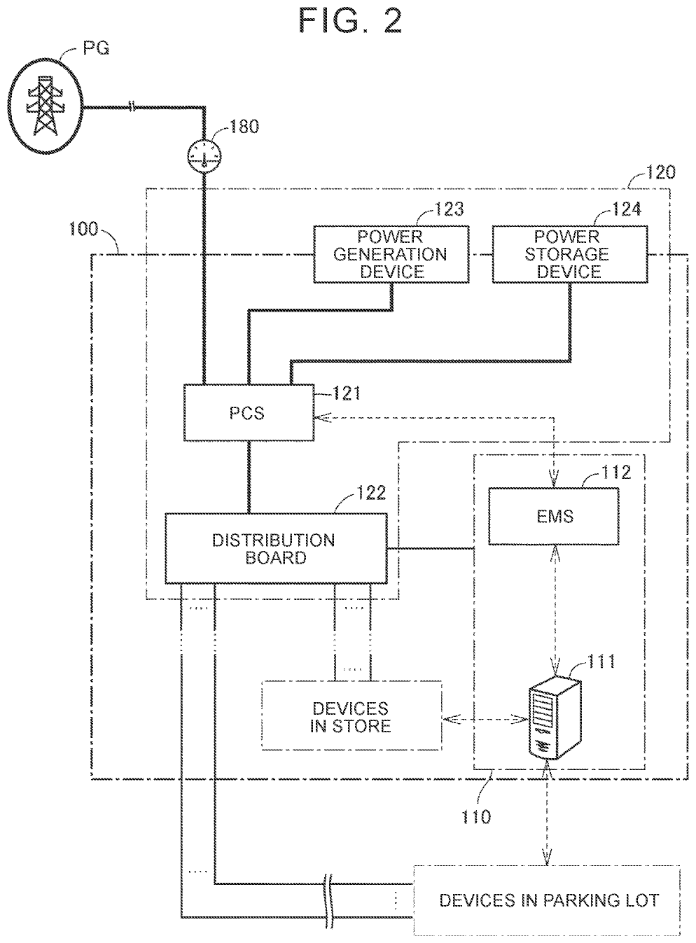

Application software for using a service provided by the store 100 (hereinafter referred to as a “convenience store application”) is installed in the mobile terminal 50. The identification information (terminal identification (ID)) of the mobile terminal 50 is registered in a control system 110 of the store 100 (more specifically, a server 111 shown in FIG. 2 to be described below) by the convenience store application. The mobile terminal 50 can exchange information with the server 111 through the convenience store application. For example, the server 111 provides coupon information to the mobile terminal 50 through the convenience store application. The server 111 manages information about a plurality of terminals (user information, point information, etc.) by distinguishing the terminals by terminal IDs.

The store 100 includes a camera 11, a wireless LAN router (hereinafter simply referred to as a “router”) 12, an automatic door device 13, shelves 14a to 14d, and a cash register (hereinafter simply referred to as a “register”) 15. The LAN means a local area network.

The camera 11 functions as a surveillance camera that monitors the inside of the store 100. The camera 11 is always in operation, and sequentially acquires and stores images of the inside of the store 100. The router 12 provides a wireless LAN for the store. For example, the use of the wireless LAN provided by the router 12 is permitted for a terminal on which the convenience store application is installed. The automatic door device 13 includes a door, a sensor for detecting a passing object, and a mechanism for automatically opening and closing the door. The automatic door device 13 automatically opens the door when detecting the approach of the passing object (for example, a person or an object), and closes the door after confirming the passage of the passing object. The automatic door device 13 may include a security gate that opens when the passing object is successfully authenticated (for example, authenticated by the convenience store application).

Products are displayed on each of the shelves 14a to 14d. Each of the shelves 14a to 14d may include at least one of a price display unit and a mechanism for product replenishment. The price display unit may include a display device that changes display contents according to an instruction from the server 111 shown in FIG. 2 to be described below, and automatically display a product price according to a situation. Each of the shelves 14a to 14d may be a sliding display shelf or a smart shelf that performs automatic inventory using a radio frequency identification (RFID) technique.

The register 15 mainly calculates fees. For example, the cashless payment at the register 15 using points (virtual currency) accumulated on the convenience store application is permitted for the terminal on which the convenience store application is installed. The register 15 may be a point of sales (POS) register equipped with a point-of-sale information management system. The POS register is configured to collect sales information. The register 15 may be an RFID-enabled self checkout.

The store 100 receives power supply from a power system PG. The power system PG includes a power grid, a power generation facility, and a substation facility. The power grid is constructed by a power transmission and distribution facility. The power system PG supplies power to a predetermined area. The store 100 is located within the predetermined area. A smart meter 180 is installed at a power receiving point of the store 100. The smart meter 180 measures the electric energy exchanged between the power system PG and the store 100.

The store 100 further includes the control system 110 and a power facility 120. FIG. 2 is a diagram showing a configuration of the control system 110 and the power facility 120.

Referring to FIG. 2 together with FIG. 1, the control system 110 includes the server 111 and an energy management system (EMS) 112. The power facility 120 includes a power conditioning system (PCS) 121, a distribution board 122, a power generation device 123, and a power storage device 124.

The power system PG, the power generation device 123, and the power storage device 124 are each electrically connected to the PCS 121. The power system PG supplies alternating current power to the PCS 121, for example. Each of the power generation device 123 and the power storage device 124 may be installed indoors or outdoors. The power generation device 123 may include at least one of a solar panel installed on the roof of the store 100 and a solar carport installed in the parking lot 200. Further, the power generation device 123 may include a wind power generation device. Further, the power generation device 123 may include a stationary fuel cell (FC) power generator that generates power through a chemical reaction between hydrogen and oxygen. The power storage device 124 may include a stationary energy storage system (ESS). The power storage device 124 may include a lithium-ion battery, a lead-acid battery, a nickel-metal hydride battery, a redox flow battery, or a sodium-sulfur (NAS) battery.

The PCS 121 includes a circuit unit and a control unit that controls the circuit unit. The circuit unit includes various circuits for executing a process related to power conditioning (for example, power conversion and input-output adjustment). The circuit unit may include an alternating current (AC)-direct current (DC) conversion circuit, a transformer circuit (for example, an isolation transformer or a DC-DC converter), and a power factor correction (PFC) circuit. The PCS 121 performs a power conversion process (for example, at least one process of AC-DC conversion, transformation, and frequency conversion) on input power, and supplies power corresponding to the distribution board 122 to the distribution board 122. Further, the PCS 121 performs the power conversion process on the input power, and outputs power suitable for charging the power storage device 124 to the power storage device 124.

The distribution board 122 supplies power to various devices (the camera 11, the router 12, the automatic door device 13, the register 15, etc.) in the store 100 shown in FIG. 1. The control system 110 (the server 111 and the EMS 112) also receives power supplied from the distribution board 122. Further, the distribution board 122 supplies power to various devices (electric vehicle service equipment (EVSE) 20a to 20d, a camera 210, a router 220, a vehicle detection sensor 230, etc.) in the parking lot 200 shown in FIG. 1.

The server 111 is configured to be able to communicate with various devices (the camera 11, the router 12, the automatic door device 13, the register 15, etc.) in the store 100. Further, the server 111 is configured to be able to communicate with various devices (the EVSE 20a to 20d, the camera 210, the router 220, the vehicle detection sensor 230, etc.) in the parking lot 200.

The EMS 112 receives information about the power facility 120 from the PCS 121 and sends a control command to the control unit of the PCS 121. Further, the EMS 112 uses the electric energy detected by the PCS 121 to create an energy management plan. Specifically, the PCS 121 includes a watthour meter that individually detects the power input to the PCS 121 from each of the power system PG, the power generation device 123, and the power storage device 124. The PCS 121 further includes a watthour meter that individually detects the power output from the PCS 121 to each of the distribution board 122 and the power storage device 124. The EMS 112 acquires energy balance information (for example, generated power, demanded power, and stored power) in the store 100 from a detection result of each watthour meter, and records the detection result over time. The EMS 112 creates an energy management plan (for example, a plan for power generation, charging, discharging, and demand limit) based on the acquired energy balance information, information about electricity fees, and a state of charge (SOC) of the power storage device 124. When the store 100 participates in a virtual power plant (VPP) to be described below, the EMS 112 creates the energy management plan in consideration of the energy balance related to the VPP as well. In addition, in a mode in which the power generation device 123 uses natural energy to generate power, the EMS 112 may predict generated power based on weather forecast information, and create the energy management plan in consideration of the generated power that has been predicted. The EMS 112 controls the PCS 121 such that energy management is executed according to the created plan while confirming the detection result of each watthour meter included in the PCS 121. The server 111 and the EMS 112 cooperate to execute the energy management while communicating with each other.

Referring to FIG. 1 again, the parking lot 200 includes the EVSE 20a to 20d, the camera 210, the wireless LAN router (hereinafter simply referred to as the “router”) 220, and the vehicle detection sensor 230. The EVSE means the electric vehicle supply equipment.

The camera 210 functions as a surveillance camera that monitors the entire parking lot 200. The camera 210 is always in operation, and sequentially acquires and stores images of the parking lot 200. The server 111 shown in FIG. 2 can acquire the images inside each store 100 and the images of the parking lot 200 from the cameras 11 and 210, respectively. The router 220 provides the wireless LAN for the entire parking lot 200. For example, the use of the wireless LAN provided by the router 220 is permitted for a terminal on which the convenience store application is installed. The server 111 shown in FIG. 2 can control the routers 12 and 220 so as to prohibit the use of the wireless LAN only for a specific terminal designated by the terminal ID.

The parking lot 200 includes parking slots P1 to P8. The parking slots P1, P2, P3, and P4 are provided with the EVSE 20a, 20b, 20c, and 20d, respectively. On the other hand, each of the parking slots P5, P6, P7, and P8 is not provided with the EVSE. Further, the vehicle detection sensor 230 is provided in each of the parking slots P1 to P8. The vehicle detection sensor 230 may be a type of sensor that is buried in the ground (for example, a loop coil) or a non-buried sensor (for example, an area sensor). The detection result by the vehicle detection sensor 230 of each of the parking slots P1 to P8 is output to the server 111 (FIG. 2). Based on these detection results, the server 111 can grasp the presence or absence of a parked vehicle in each of the parking slots P1 to P8. For example, in the state shown in FIG. 1, vehicles 30a, 30b, 30c, 30d, and 30e are parked in the parking slots P2, P4, P5, P7, and P8, respectively, and the parking slots P1, P3, and P6 are empty. The state (parked/empty) of each parking slot in the parking lot 200 may be detected by the surveillance camera (camera 210) or a three-dimensional light detection and ranging (3D-LiDAR) parking management system, instead of the vehicle detection sensor.

Each of the EVSE 20a to 20d installed in the parking lot 200 is, for example, a charger with a power supply function, and is configured to be able to charge the power storage device mounted on the vehicle. A vehicle electrically connected to any of the EVSE 20a to 20d can execute the energy management.

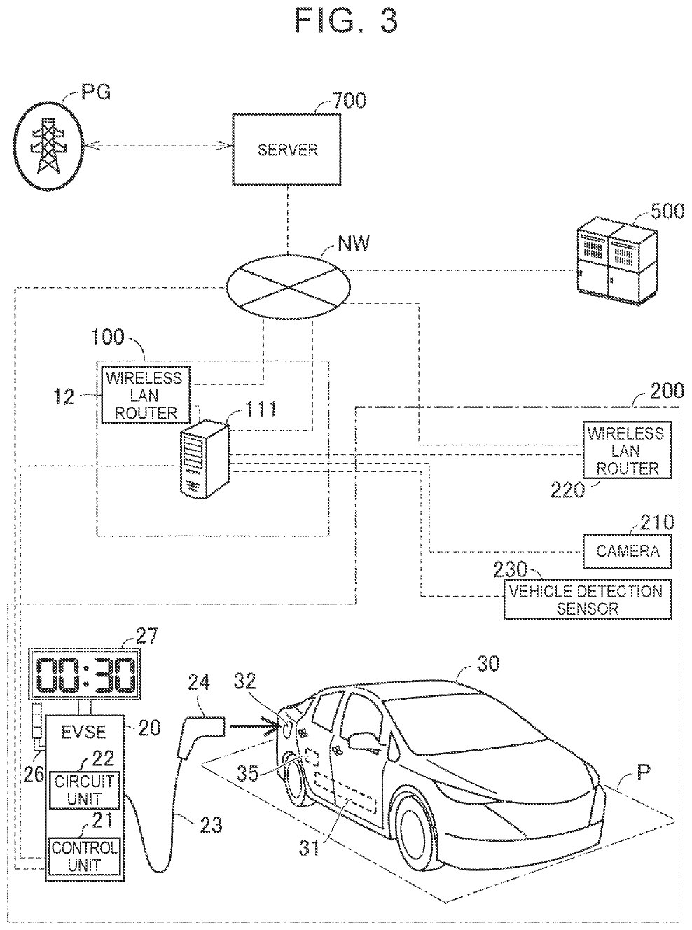

FIG. 3 is a diagram illustrating the energy management using the EVSE 20a to 20d in the store 100. In the present embodiment, the EVSE 20a to 20d shown in FIG. 1 have the same configuration, so hereinafter the EVSE 20a to 20d are referred to as the “EVSE 20” when they are not distinguished from each other. Further, the parking slots P1 to P4 each provided with the EVSE 20 are also referred to as the “parking slot P” when they are not distinguished from each other. A vehicle 30 shown in FIG. 3 corresponds to an example of a vehicle configured to be able to use the EVSE 20. Each of the vehicles 30a to 30e shown in FIG. 1 may have a configuration corresponding to the vehicle 30 described below. A user of the vehicle 30 owns the mobile terminal 50 described above.

Referring to FIG. 3 together with FIGS. 1 and 2, a server 700 corresponds to a computer belonging to a transmission system operator (TSO) of the power system PG. A server 500 corresponds to a computer belonging to an aggregator. The server 111 (the store 100), the server 500, and the server 700 are configured to be able to communicate with each other via a communication network NW. The communication network NW is, for example, a wide area network constructed by the Internet and wireless base stations. Further, the wireless LAN provided by the routers 12 and 220 is connected to the communication network NW. The mobile terminal 50 (FIG. 1) can be connected to the communication network NW via the wireless LAN provided by the router 12 or 220.

As each of the servers 111, 500, and 700, a computer having a processor, a random-access memory (RAM), and a storage device can be adopted. As the processor for example, a central processing unit (CPU) can be adopted. The storage device is an example of a storage medium. The storage device is configured to be able to save stored information. The storage device may include a rewritable non-volatile memory. In each computer, various processes are executed by the processor executing a program stored in the storage device. However, execution of the various processes is not limited to execution by software, and the processes can be executed by dedicated hardware (electronic circuit).

The server 500 is configured to bundle a plurality of distributed energy resources (hereinafter also referred to as “distributed energy resources (DER)”) by advanced energy management technology using Internet of Things (IOT), and realize the virtual power plant (VPP). The VPP is a mechanism that causes the remotely and integratedly controlled DER to function as if it were a single power plant. For example, when the energy management of the power system PG is requested from the server 700, the server 500 requests a server managing a DER electrically connected to the power system PG to allow the DER to participate in the VPP. For example, the vehicle 30 electrically connected to the EVSE 20 can function as the DER for the VPP. Therefore, in response to the request from the server 700, the server 500 requests the server 111 to allow the vehicle 30 electrically connected to the EVSE 20 to participate in the VPP.

The vehicle 30 further includes a battery 31 and an electronic control unit (hereinafter referred to as an “ECU”) 35. The ECU 35 is a computer provided with a processor and a storage device, for example. The vehicle 30 is an electrified vehicle (xEV) configured to be able to travel using power stored in the battery 31. The vehicle 30 may be a battery electric vehicle (BEV) that does not include an internal combustion engine or a plug-in hybrid electric vehicle (PHEV) that includes an internal combustion engine. As the battery 31, a known vehicle power storage device (for example, a liquid secondary battery, an all-solid-state secondary battery, or an assembled battery) can be adopted. Examples of a vehicle secondary battery include a lithium ion battery and a nickel-metal hydride battery.

The EVSE 20 is installed in the vicinity of the parking slot P, and is configured to be able to charge the battery 31 mounted on the vehicle 30 parked in the parking slot P. The body of the EVSE 20 incorporates a control unit 21 and a circuit unit 22. Further, the EVSE 20 further includes a charging cable 23, a warning light 26, and a display device 27. The control unit 21 includes a processor and a storage device, and is configured to control the circuit unit 22 according to a command from the server 111 or 500. The circuit unit 22 includes a circuit for supplying power to the vehicle 30 (for example, charging the battery 31) and a circuit for supplying power to the power system PG (reverse power flow). The charging cable 23 includes a connector 24 (plug) at the tip thereof.

The vehicle 30 includes an inlet 32 to which the connector 24 is attachable and from which the connector 24 is detachable. The inlet 32 corresponds to a charge-discharge port that functions as both a charge port and a discharge port. The connector 24 of the charging cable 23 connected to the body of the EVSE 20 is connected to the inlet 32 of the parked vehicle 30, so that the vehicle 30 is in a state in which the vehicle 30 is electrically connected to the EVSE 20 (hereinafter also referred to as a “plug-in state”). On the other hand, for example, while the vehicle 30 is traveling, the vehicle 30 is in a state in which the vehicle 30 is not electrically connected to the EVSE 20 (hereinafter also referred to as a “plug-out state”).

The EVSE 20 includes a connection detection circuit (not shown) that detects the state of the connector 24 (plug-in state/plug-out state). The connection detection circuit outputs the state of connector 24 to the control unit 21. Further, the control unit 21 acquires, from a sensor included in the circuit unit 22 (not shown), information indicating the operation status of the EVSE 20 (for example, input power from the power system PG, output power to the vehicle 30, input power from the vehicle 30, and output power to the power system PG). In the present embodiment, the use of the EVSE 20 is permitted only for a user who has authenticated to the EVSE 20 through the mobile terminal 50 (convenience store application). The identification information (terminal ID) of the mobile terminal 50 is input to the EVSE 20 by this authentication. The EVSE 20 (control unit 21) then transmits the terminal ID to the server 111 together with the identification information of the EVSE 20. The server 111 can specify the user using the EVSE 20 based on the terminal ID received from the EVSE 20. The information about the EVSE 20 is sequentially transmitted from the EVSE 20 to the server 111 while the EVSE 20 is being used.

Power is supplied from the power system PG to the EVSE 20 via the PCS 121 and the distribution board 122 shown in FIG. 2. When the battery 31 is charged in the plug-in state, the circuit unit 22 of the EVSE 20 converts the power to be supplied into power suitable for supplying power to the vehicle 30, and the converted power is output to the connector 24 of the charging cable 23. In this case, the battery 31 is charged with the power input from the connector 24 to the inlet 32. When the battery 31 is discharged in the plug-in state, the circuit unit 22 of the EVSE 20 converts the power from the vehicle 30 (the power discharged from the battery 31) into power corresponding to the power system PG, and the converted power is output to the power system PG via the distribution board 122 and the PCS 121 shown in FIG. 2. Thus, the EVSE 20 is configured to allow reverse power flow to the power system PG.

In the plug-in state, the control unit 21 of the EVSE 20 and the ECU 35 of the vehicle 30 perform wired communication via a communication line in the charging cable 23. In the EVSE 20, the circuit unit 22 charges or discharges the battery 31 as described above according to a command from the control unit 21. While the battery 31 is being charged or discharged, the control unit 21 receives the state of the battery 31 (for example, the temperature, the current, the voltage, and the SOC) from the ECU 35, and controls the circuit unit 22 such that the charging power or the discharging power is close to a target value. The SOC indicates the remaining amount of power, and represents, for example, the ratio of the current power storage amount to the power storage amount in a fully charged state from 0% to 100%.

The warning light 26 is controlled by the server 111. The warning light 26 is configured to be switchable between presence and absence of warning. The warning light 26 issues a warning when instructed to issue a warning by the server 111, and stops the warning when instructed to stop the warning by the server 111. The warning light 26 may be extinguished in normal times, and may blink or be lit during a warning. Further, the warning light 26 may be lit in a first color (for example, green) in normal times, and may be lit in a second color (for example, red) during a warning. The warning light 26 may have a speaker function, and may cause a sound to occur during a warning.

The display device 27 displays the remaining time until the parking time limit of the vehicle 30 parked in the parking slot P. In the state shown in FIG. 3, the display device 27 displays “30 minutes” as the remaining time. Although the details will be described below, the remaining time until the parking time limit corresponds to the time limit for which the store allows the user to park the vehicle.

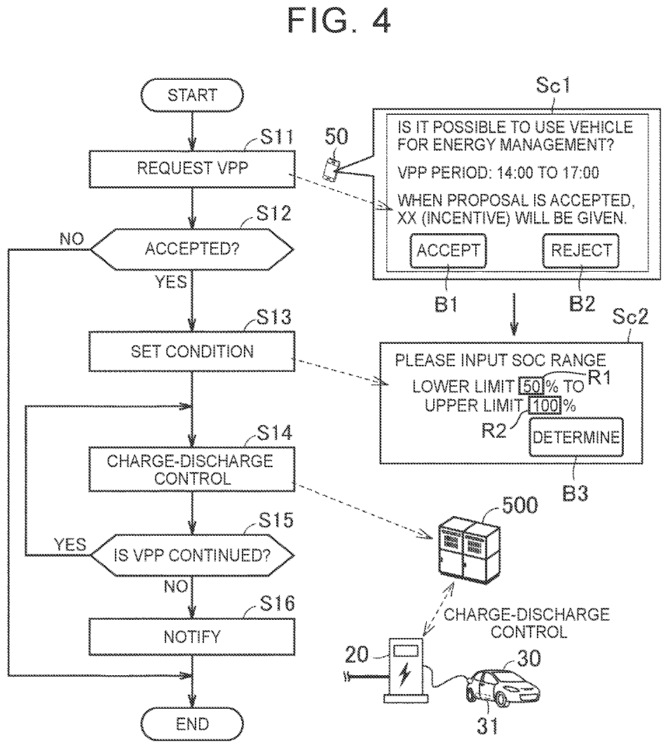

FIG. 4 is a flowchart showing a process related to the energy management in a parking lot management method according to the present embodiment. A series of processes shown in this flowchart is executed by the server 111 for the vehicle 30 in the plug-in state in the parking slot P of the parking lot 200 when the server 111 receives a VPP participation request from the server 500. When the vehicle 30 in the plug-in state is parked in each of the parking slots P, the server 111 executes the series of processes of S11 to S16 described below for each vehicle 30 in the plug-in state. “S” in the flowchart means a step.

Referring to FIG. 4 together with FIGS. 1 to 3, in S11, the server 111 requests the vehicle 30 to perform the energy management. Specifically, the server 111 sends a request signal to the mobile terminal 50 corresponding to the vehicle 30 (that is, the mobile terminal 50 carried by the user of the vehicle 30), and requests the mobile terminal 50 to reply with either acceptance or rejection. The mobile terminal 50 that has received the request signal displays a screen Sc1, for example. The screen Sc1 displays a message requesting the energy management, and information about an energy management period (hereinafter also referred to as a “VPP period”) and an incentive. Further, the screen Sc1 displays an operation unit B1 for receiving input of the acceptance and an operation unit B2 for receiving input of the rejection. When the user operates the operation unit B1, the mobile terminal 50 sends the reply with acceptance to the server 111. When the user operates the operation unit B2, the mobile terminal 50 sends the reply with rejection to the server 111.

In subsequent S12, the server 111 determines whether the request for the energy management has been accepted. When the server 111 receives the reply with rejection from the user of the vehicle 30 to which the energy management has been requested, or when there is no reply within a predetermined time after the request, it is determined that the request for the energy management has not been accepted (NO in S12), and the series of processes shown in FIG. 4 ends.

When the server 111 receives the reply with acceptance from the user of the vehicle 30 to which the energy management has been requested, it is determined YES in S12, and the process proceeds to S13. In S13, the server 111 requests the mobile terminal 50 for a user condition regarding the charge-discharge control of the battery 31 (that is, a condition set by the user). Specifically, in response to the request from the server 111, the mobile terminal 50 requests the user to input the condition regarding the charge-discharge control of the battery 31. In the present embodiment, the mobile terminal 50 requests the user to input the SOC range of the battery 31 for which control by an external device (for example, the server 500) is allowed. The mobile terminal 50 displays a screen Sc2, for example. The screen Sc2 displays input units R1 and R2 for receiving input of the SOC range (a lower limit value and an upper limit value) and a determination button B3. When the user specifies the SOC range using the input units R1 and R2, and operates the determination button B3, the condition designated by the user (the SOC range) is transmitted from the mobile terminal 50 to the server 111. The display content of the screen Sc2 can be changed as appropriate. For example, the screen Sc2 may prompt the user to input only the lower limit value of the SOC. Further, the screen Sc2 may prompt the user to input other conditions (for example, scheduled departure time) instead of or in addition to the SOC range. The server 111 may change the VPP period of the vehicle 30 according to the scheduled departure time specified by the user.

Subsequently, in S14, the server 111 sends information about the EVSE 20 electrically connected to the vehicle 30 (for example, information necessary for the charge-discharge control) to the server 500, and permits the server 500 to remotely control the EVSE 20. In the present embodiment, the server 111 transmits the condition specified by the user in S13 to the server 500. Further, the server 111 may send information about the EVSE 20 electrically connected to the vehicle 30 (for example, a location, communication address, and specifications) to the server 500.

The server 500 that has received permission for the remote control from the server 111 performs the charge-discharge control of the battery 31 while communicating with the control unit 21 of the EVSE 20. The server 500 causes the vehicle 30 to execute the energy management (for example, the energy management of the power system PG) for the VPP through such charge-discharge control. At this time, the server 500 performs the charge-discharge control of the battery 31 according to the condition specified by the user. In the present embodiment, the server 500 performs the charge-discharge control of the battery 31 within the SOC range specified by the user. When the SOC of the battery 31 is below the lower limit value specified by the user, the server 500 performs the charge-discharge control of the battery 31 for the energy management within the SOC rage specified by the user after charging the battery 31 until the SOC of the battery 31 becomes equal to or higher than the lower limit value. Therefore, the SOC of the battery 31 does not fall below the lower limit value specified by the user during execution of the energy management. As a result, even when the vehicle 30 withdraws from the energy management at any timing, the electric energy (SOC) required for the next travel can be easily stored in the battery 31.

The energy management by the vehicle 30 is started by the process of S14. Subsequently, the server 111 determines in S15 whether the energy management is continued. Specifically, the server 111 determines whether a predetermined VPP continuation condition is satisfied. In the present embodiment, when any of end requirements, which are a state in which the vehicle 30 is in the plug-out state (first end requirement), a state in which an end request is transmitted from the mobile terminal 50 corresponding to the vehicle 30 to the server 111 (second end requirement), and a state in which the energy management is completed (third termination requirement), is not satisfied, the VPP continuation condition is satisfied, and when any of the end requirements is satisfied, the VPP continuation condition is not satisfied.

During execution of the energy management, the server 111 may sequentially transmit the SOC of the vehicle 30 to the mobile terminal 50 corresponding to the vehicle 30. The user may check the current SOC displayed by the mobile terminal 50, and determine whether the energy management is continued. When the user transmits the end request to the server 111 through the mobile terminal 50 (convenience store application), the second end requirement is satisfied. Thus, the user of the vehicle 30 can stop the energy management at any timing. The third end requirement is satisfied, for example, by the arrival of the end time of the VPP period.

During execution of the energy management (YES in S15), the processes of S14 and S15 are repeatedly executed. On the other hand, when any of the end requirements described above is satisfied (NO in S15), the energy management ends. In this case, in S16, the server 111 sends a message indicating the end of the energy management together with the reason to the mobile terminal 50 corresponding to the vehicle 30. This message is displayed on the mobile terminal 50. When the process of S16 is executed, the series of processes shown in FIG. 4 ends. The remote control of the EVSE 20a to 20d by the server 500 is prohibited while the energy management is not being executed.

When the energy management for the VPP ends, the server 111 provides the user of the vehicle 30 with an incentive (for example, points) according to the performance of the energy management through the convenience store application. For example, a part of the incentive paid by the aggregator to the store owner of the store 100 as consideration for participating in the VPP is returned to the user of the vehicle 30. The server 111 may determine the incentive based on the condition specified in S13. For example, the incentive that the user obtains may be high as the SOC range specified in S13 is wide. The message sent in S16 may include incentive information obtained by the user (for example, the number of given points). The points may be treated as virtual currency, or may be redeemed for cash. Further, the points may be converted into goods or rights (for example, rights to receive services commensurate with the number of points).

By the way, parking the vehicle in the parking lot 200 for a long time tends to result in a lower turnover rate of customers in the store 100. On the other hand, there is a possibility that utilizing the vehicle parked in the parking lot 200 for management of the store will be advantageous for both the store owner and the user of the vehicle. Therefore, the server 111 according to the present embodiment executes the display control described below, thereby suppressing long-time parking that is disadvantageous to the store while promoting the utilization of the vehicle 30 parked in the parking lot 200.

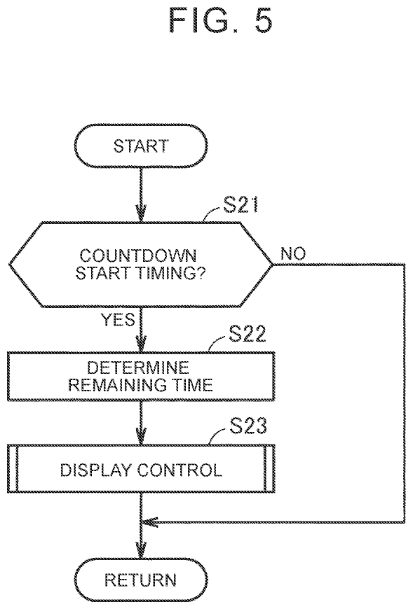

FIG. 5 is a flowchart showing a process related to the display control in the parking lot management method according to the present embodiment. A series of processes shown in this flowchart is repeatedly executed by the server 111. The server 111 executes the processes of S21 to S23 described below for the vehicle 30 that is in the plug-in state in the parking slot P of the parking lot 200. When the vehicle 30 in the plug-in state is parked in each of the parking slots P, the server 111 executes the series of processes of S21 to S23 described below for each vehicle 30 in the plug-in state.

Referring to FIG. 5 together with FIGS. 1 to 3, in S21, the server 111 determines whether a countdown start timing set for the vehicle 30 (hereinafter referred to as a “CDST”) has arrived. In the present embodiment, the timing at which charging of the battery 31 of the vehicle 30 using the EVSE 20 is started is set as the CDST.

The CDST is not limited to the above, and can be changed as appropriate. For example, the timing at which the vehicle 30 starts parking in the parking slot P may be set as the CDST. Further, the timing at which the user of the vehicle 30 has completed payment at the register 15 may be set as the CDST. The store clerk may allow the server 111 to set any CDST. Further, the server 111 may change the CDST according to the time zone. The server 111 may set a different CDST for each user (for each vehicle 30). The server 111 may set the timing at which the user has completed payment at the register 15 as the CDST for a user who is a paid member, and may set the timing at which charging by the EVSE 20 is started as the CDST for other users.

Subsequently, in S22, the server 111 determines the remaining time until the parking time limit of the vehicle 30 parked in the parking slot P. The remaining time determined here may be a fixed value (for example, 10 minutes) or may be variable depending on the situation. For example, the server 111 may increase the remaining time (time limit for which the store allows the user to park the vehicle) as the number of empty parking slots in the parking lot 200 is large.

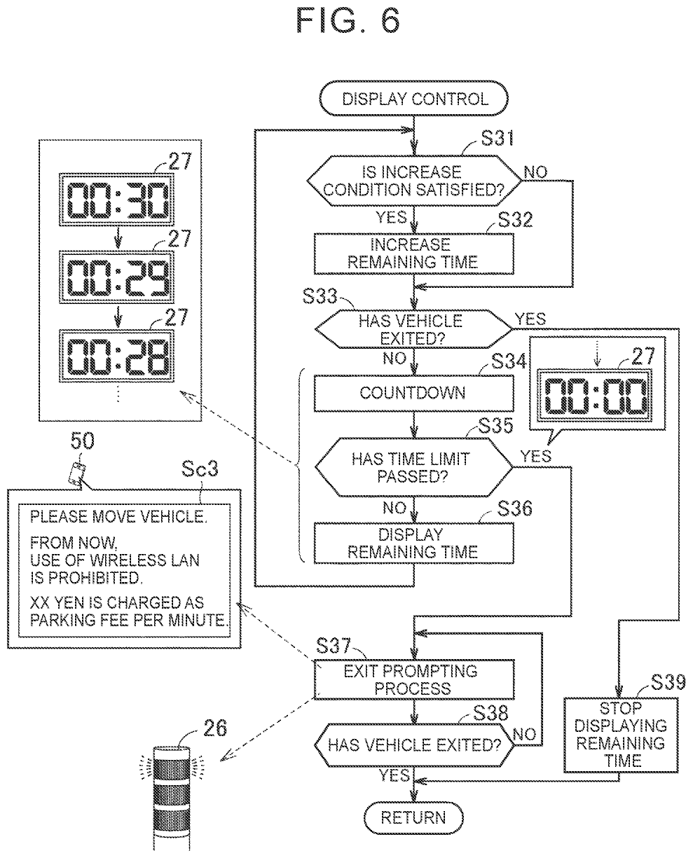

Subsequently, in S23, the server 111 executes the display control shown in FIG. 6 to be described below. FIG. 6 is a flowchart showing the details in S23.

Referring to FIG. 6 together with FIGS. 1 to 3, in S31, the server 111 determines whether a predetermined increase condition is satisfied. In the present embodiment, the increase condition is satisfied when the server 111 receives the reply with acceptance from the user of the vehicle 30 in response to the energy management request (S11 in FIG. 4). When the server 111 receives the VPP participation request from the server 500 while the vehicle 30 is in the plug-in state in the parking slot P, the series of processes shown in FIG. 4 is executed in parallel with the series of processes shown in FIG. 5. The increase condition is not satisfied when the server 111 receives the reply with rejection from the user of the vehicle 30 in response to the energy management request (S11 in FIG. 4).

Further, when the user of the vehicle 30 enters the store 100, the increase condition is satisfied. Further, even when the user who has entered the store 100 makes a purchase within the store 100, the above increase condition is satisfied. The register 15 may specify the user who has made a purchase by the terminal ID. The mobile terminal 50 can send the terminal ID to the register 15 through the convenience store application. The increase condition is not limited to the above, and can be set as appropriate. The store clerk may allow the server 111 to set any increase condition.

When the increase condition is satisfied (YES in S31), the process proceeds to S33 through S32. In S32, the server 111 increases the remaining time until the parking time limit of the vehicle 30 (see S22 in FIG. 5). For example, when the user of the vehicle 30 accepts the energy management (participation in the VPP) and the increase condition is satisfied, the server 111 increases the remaining time by a predetermined time (for example, the time corresponding to the VPP period). As a result, the remaining time when the vehicle 30 executes the energy management becomes longer than the remaining time when the vehicle 30 does not execute the energy management. The server 111 may set the remaining time (and thus the parking time limit) according to the VPP period such that the vehicle 30 can continue to be parked in the parking slot P during the VPP period. Further, when the user of the vehicle 30 enters the store 100 and the increase condition is satisfied, the server 111 increases the remaining time by a predetermined time (for example, 30 minutes). As a result, the remaining time when the user of the vehicle 30 enters the store 100 becomes longer than the remaining time when the user of the vehicle 30 does not enter the store 100. After that, when the user who has entered the store 100 does shopping in the store 100, the server 111 further increases the remaining time by a predetermined time (for example, 30 minutes). The server 111 may change the increase time depending on an item the user has purchased. The server 111 may, for example, increase the remaining time as the item the user has purchased is expensive. This makes it possible to increase the user's willingness to purchase expensive items. Further, the server 111 may, for example, increase the remaining time as the item the user has purchased is close to the expiration date. As a result, food loss can be reduced.

On the other hand, when the increase condition is not satisfied (NO in S31), the process proceeds to S33 without going through S32. In this case, the remaining time is not increased (S32).

In S33, the server 111 determines whether the vehicle 30 has exited. For example, the server 111 may determine whether the vehicle 30 has exited based on a signal from the vehicle detection sensor 230 corresponding to the parking slot P in which the vehicle 30 is parked. When the vehicle 30 has exited from the parking slot P (YES in S33), the server 111 stops displaying the remaining time on the display device 27 (see S36 to be described below) in S39. As a result, the display device 27 is brought into a non-display state. S23 of FIG. 5 ends together with the series of processes shown in FIG. 6 by execution of the process in S39. As a result, the series of processes shown in FIG. 5 also ends. Determination of YES in S33 means that the vehicle 30 has exited from the parking slot P before the parking time limit.

On the other hand, when the vehicle 30 stays in the parking slot P (NO in S33), the server 111 starts counting down the remaining time (the remaining time determined in S22 of FIG. 5 or the remaining time increased in S32) in S34. In the first processing routine, the server 111 starts counting down the remaining time, and in the second and subsequent processing routines, the server 111 continues counting down the remaining time. Due to this countdown, the remaining time decreases as time elapses.

In S35, the server 111 determines whether the parking time limit of the vehicle 30 has passed. The parking time limit corresponds to a timing when the remaining time has passed from the current time. When the remaining time counted down in S34 is not zero, it means that the parking time limit of the vehicle 30 has not passed. Further, when the remaining time counted down in S34 is zero, it means that the parking time limit of the vehicle 30 has passed.

When the parking time limit of the vehicle 30 has not passed (NO in S35), in S36, the server 111 controls the display device 27 such that the display device 27 displays the current remaining time. After that, the process returns to S31. During a period in which the vehicle 30 has not exited from the parking slot P and the parking time limit of the vehicle 30 has not passed (NO in both S33 and S35), the processes of S31 to S36 are repeated. During this period, the server 111 causes the display device 27 to display the remaining time while counting down the remaining time (S34 to S36). However, when the increase condition is satisfied, the remaining time is increased by the process of S32.

When the parking time limit of the vehicle 30 has passed (YES in S35), the server 111 executes an exit prompting process in S37. The exit prompting process is a process of prompting the vehicle 30 to exit from the parking slot P. In the present embodiment, the exit prompting process includes a notification process and a wireless LAN use prohibition process for the mobile terminal 50 corresponding to the vehicle 30 (that is, the mobile terminal 50 carried by the user of the vehicle 30), a billing process for the user of the vehicle 30, and a warning process by the warning light 26 corresponding to the vehicle 30 (that is, the warning light 26 of the EVSE 20 connected to the vehicle 30). Specifically, the server 111 sends, to the mobile terminal 50, a notification prompting the vehicle 30 to exit. Upon receiving the notification from the server 111, the mobile terminal 50 displays a screen Sc3, for example. The screen Sc3 includes a message prompting the user of the vehicle 30 to exit. In addition, the server 111 controls the routers 12, 220 so as to prohibit the use of the wireless LAN (more specifically, the communication network provided by the store 100 within the premises of the store 100 through the routers 12, 220) by the mobile terminal 50. As a result, convenience for the user of the vehicle 30 within the premises of the store 100 (including the parking lot 200) is reduced. Further, the server 111 controls the warning light 26 provided for the parking slot P such that the warning light 26 issues a warning urging the vehicle 30 to exit from the parking slot P. Further, the server 111 charges the user of the vehicle 30 with a parking fee. The server 111 charges the user of the vehicle 30 with a predetermined parking fee each time a unit time (for example, one minute) elapses through the mobile terminal 50 (convenience store application). The user may pay the charged parking fee with points (virtual currency) accumulated on the convenience store application.

The exit prompting process is not limited to the process described above, and can be set as appropriate. For example, the exit prompting process may include, in addition to the above-described processes (the notification process, the wireless LAN use prohibition process, the billing process, and the warning process), or in place of at least one of the above-described processes, a discharge process (forced discharge process) of the battery 31 mounted on the vehicle 30. Specifically, in S37, the server 111 may control the EVSE 20 corresponding to the vehicle 30 such that discharging is performed from the battery 31 mounted on the vehicle 30 to the distribution board 122. The discharged power may be stored in the power storage device 124.

In subsequent S38, the server 111 determines whether the vehicle 30 has exited according to the exit prompting process. For example, the server 111 may determine whether the vehicle 30 has exited based on a signal from the vehicle detection sensor 230 corresponding to the vehicle 30. While the vehicle 30 has not exited (NO in S38), S37 and S38 are repeated. As a result, the exit prompting process is continuously executed. When the vehicle 30 exits in response to the exit prompting process (YES in S38), S23 in FIG. 5 ends together with the series of processes shown in FIG. 6. As a result, the series of processes shown in FIG. 5 also ends.

As described above, the parking lot management method according to the present embodiment includes the series of processes shown in FIGS. 4 to 6. The series of processes shown in FIG. 4 includes requesting the energy management to the vehicle 30 parked in the parking slot P (S11). The series of processes shown in FIGS. 5 and 6 includes displaying the remaining time until the parking time limit of the vehicle 30 (S22, S31 to S36). Displaying the remaining time includes increasing the remaining time when the vehicle executes the energy management as compared with the remaining time when the vehicle does not execute the energy management (S31, S32). More specifically, displaying the remaining time includes determining the remaining time based on the reply with acceptance or rejection from the user of the vehicle 30 to the request for the energy management (S31, S32), and causing the display device 27 to display the determined remaining time (S36).

According to the above method, for the vehicle 30 parked in the parking slot P, the remaining time until the parking time limit (that is, the time limit for which the store allows the user to park the vehicle) is displayed. By showing the remaining time to a surrounding area, deterrence works by surrounding eyes, and the long-time parking that exceeds the parking time limit (that is, the long-time parking that is disadvantageous to the store) is suppressed. Further, by increasing the remaining time when the vehicle 30 executes the energy management as compared with the remaining time when the vehicle 30 does not execute the energy management, it is possible to prompt the vehicle 30 to participate in the energy management. This makes it easier for the vehicle 30 parked in the parking lot 200 of the store 100 to be utilized for the store. Participation of the vehicle 30 in the energy management allows the store owner to receive the incentive from the aggregator. On the other hand, the user of vehicle 30 is allowed to park the vehicle 30 in the parking lot 200 for a long time. Therefore, the user of the vehicle 30 can stay in the parking lot 200 for a long period of time and take a rest. Alternatively, the user of the vehicle 30 can leave the vehicle 30 in the parking lot 200 and run errands nearby.

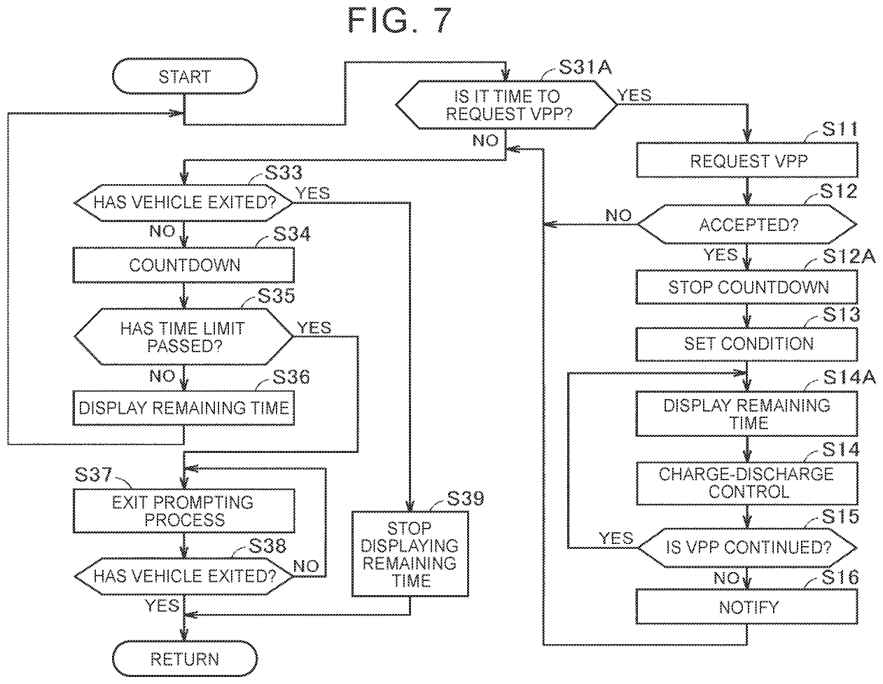

The server 111 may execute a process shown in FIG. 7 described below instead of the process shown in FIG. 6. FIG. 7 is a flowchart showing a modification of the process shown in FIG. 6. The series of processes shown in FIG. 7 includes S33 to S39 shown in FIG. 6, and does not include S31 and S32 shown in FIG. 6. The series of processes shown in FIG. 7 includes new steps (S31A, S12A, and S14A) in addition to S11 to S16 shown in FIG. 4. The process shown in FIG. 4 is not executed in the modification described below. The series of processes shown in FIG. 7 is executed in S23 of FIG. 5.

Referring to FIG. 7 together with FIGS. 1 to 3, in this modification, the server 111 first determines in S31A whether it is time to request the energy management. The server 111 determines YES in S31A when receiving the VPP participation request from the server 500, and determines NO in S31A when not receiving the VPP participation request from the server 500.

When it is determined NO in S31A, the process proceeds to S33. Then, when the process of S36 is executed, the process returns to S31A. During a period in which the vehicle 30 has not exited from the parking slot P and the parking time limit of the vehicle 30 has not passed (NO in both S33 and S35), the processes of S31A and S33 to S36 are repeated.

On the other hand, when it is determined YES in S31A, the server 111 executes the processes of S11 and S12. When the user of vehicle 30 accepts the request for the energy management (YES in S12), the server 111 stops counting down the remaining time in S12A, and then executes the process of S13. Subsequently, in S14A, the server 111 controls the display device 27 such that the display device 27 displays the current remaining time. Subsequently, the server 111 executes the processes of S14 and S15. During the execution of the energy management (YES in S15), the processes of S14A, S14, and S15 are repeatedly executed. Even during the execution of the energy management, the countdown of the remaining time has stopped, and the remaining time displayed in S14A does not change. The display device 27 continues to display the same time. Then, when the energy management ends (NO in S15), the server 111 executes the process of S16.

When the energy management request is rejected (NO in S12), or when the process of S16 is executed, the process proceeds to S33. Therefore, when the vehicle 30 parked in the parking slot P is not executing the energy management, the processes of S33 to S36 are repeated. As a result, the remaining time is counted down, and the remaining time that is sequentially counted down is displayed on the display device 27.

The parking lot management method according to the modification includes the series of processes shown in FIG. 7. The series of processes shown in FIG. 7 includes displaying the remaining time while the remaining time is counted down when the vehicle 30 is not executing the energy management (S34 to S36), and displaying the remaining time while the remaining time is not counted down when the vehicle 30 is executing the energy management (S12A, S14A, S14, and S15). This method also makes it possible to utilize the vehicles 30 parked in the parking lot 200 of the store 100 while suppressing the long-time parking that is disadvantageous to the store.

The power system PG (external power source) is not limited to a large-scale AC grid, and may be a micro grid or a direct current (DC) grid. Further, the configuration of the energy management system is not limited to the configuration shown in FIG. 3. For example, the functions of the server 500 may be implemented in the server 111, and the server 500 may be omitted.

In the above embodiment and modification, the server 111 has a program that causes a computer to execute the parking lot management method shown in FIGS. 4 to 7. The server 111 includes a storage device that stores such a program and a processor that executes the program. That is, in the above embodiment, the parking lot management method is executed by an on-premises server (the server 111 shown in FIG. 2). However, the present disclosure is not limited to this, and the functions of the server 111 (especially functions related to parking lot management) may be implemented on the cloud by cloud computing.

The various modifications described above may be implemented in any combination. The embodiment disclosed herein should be considered to be exemplary and not restrictive in all respects. The scope of the present disclosure is shown by the scope of claims rather than the description of the above embodiment, and is intended to include all modifications within the meaning and the scope equivalent to the scope of claims.

What is claimed is:

1. A parking lot management method for managing a parking lot, the parking lot including a parking slot and a power supply facility configured to be able to charge a power storage device mounted on a vehicle parked in the parking slot, the parking lot management method comprising:
requesting energy management to the vehicle parked in the parking slot; and
displaying a remaining time until a parking time limit of the vehicle, wherein displaying the remaining time includes increasing the remaining time when the vehicle executes the energy management as compared with the remaining time when the vehicle does not execute the energy management.

2. The parking lot management method according to claim 1, wherein displaying the remaining time includes:
determining the remaining time based on a reply with acceptance or rejection from a user of the vehicle to a request of the energy management; and
displaying the determined remaining time on a display device.

3. The parking lot management method according to claim 1, wherein displaying the remaining time includes:
displaying the remaining time while the remaining time is counted down when the vehicle is not executing the energy management; and
displaying the remaining time without counting down the remaining time when the vehicle is executing the energy management.

4. The parking lot management method according to claim 1, wherein displaying the remaining time further includes increasing the remaining time when a user of the vehicle uses a facility as compared with the remaining time when the user of the vehicle does not use the facility.

5. The parking lot management method according to claim 1, wherein the parking lot management method further includes executing a process of prompting the vehicle to exit from the parking slot when the parking time limit has passed.

6. The parking lot management method according to claim 5, wherein executing the process of prompting the vehicle to exit includes at least one of:
issuing a warning by a warning light provided for the parking slot;
charging a user of the vehicle with a parking fee; and
discharging the power storage device mounted on the vehicle.

7. A non-transitory storage medium storing a program that causes a computer to execute the parking lot management method according to claim 1.

8. A computer device comprising a storage device for storing the program according to claim 7 and a processor for executing the program.
